(19) United States
(12) Patent Application Publication
(10) Pub. No.: US 2004/0016125 A1
(43) Pub. Date: Jan. 29, 2004

(54) Disk cutter having cutter inserts arranged at unequal pitches

(75) Inventors: Tanehiko Asada, Iwata-gun (JP); Hisao Sakai, Iwata-gun (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TENRYU SEIKYO KABUSHIKI KAISHA, Iwata-gun (JP)

(21) Appl. No.: 10/242,622

(22) Filed: Sep. 13, 2002

(30) Foreign Application Priority Data
Jul. 23, 2002 (JP) 2002-213631

(51) Int. Cl. B26B 1/00; B27B 13/02; B27B 33/14

(52) U.S. Cl. 30/1; 83/835; 83/846

(57) ABSTRACT

A disk cutter including an annular disk-shaped base adapted to be driven about an axis of rotation; a plurality of tip supports formed along the outer circumference of the base integrally therewith so that a gullet is defined between adjacent ones of the tip supports; and a plurality of hardened cutter inserts respectively fixed to the tip supports. The base is imaginarily divided into a plurality of segments by radially extending lines. The hardened cutter inserts in each segment are arranged symmetrically with respect to a circumferential center line of the segment so that the pitches of the hardened cutter inserts on each side of the circumferential center line are stepwise increased in a direction from the circumferential center line toward the radially extending line on the same side.

### BACKGROUND OF THE INVENTION

1. Field of the Invention

The present invention relates to a disk cutter or circular tip saw.

2. Description of the Related Art

Well known is a disk cutter or tip saw including a metallic base (base disk) having a plurality of tip supports arranged along the outer circumference and a plurality of hardened cutting tip inserts (cutter inserts) respectively fixed to the tip supports by brazing or the like. The tip supports are spaced at given intervals in the circumferential direction of the base disk or annular disk-shaped base, and a gullet (chip space) is defined between adjacent ones of the tip supports. Each cutter insert is fixed to the corresponding tip support by brazing or the like.

As mentioned above, in the conventional disk cutter, the plural cutter inserts are fixed to the outer circumference of the base disk so as to be spaced at fixed pitches in the circumferential direction of the base disk. Such a disk cutter has problems such that the load on the disk cutter during cutting is relatively heavy and that resonance is apt to occur.

### SUMMARY OF THE INVENTION

It is therefore an object of the present invention to provide a disk cutter which can reduce the load during cutting and prevent the occurrence of resonance.

In accordance with an aspect of the present invention, there is provided a disk cutter including an annular disk-shaped base adapted to be driven about an axis of rotation; a plurality of tip supports formed along the outer circumference of the base integrally therewith so that a gullet is defined between adjacent ones of the tip supports; and a plurality of hardened cutter inserts respectively fixed to the tip supports; the base being imaginarily divided into a plurality of segments by radially extending lines; the hardened cutter inserts in each segment being arranged symmetrically with respect to a circumferential center line of the segment so that the pitches of the hardened cutter inserts on each side of the circumferential center line are stepwise increased in a direction from the circumferential center line toward the radially extending line on the same side.

Preferably, the distance between the bottom of each gullet and the top of the corresponding hardened cutter insert is set symmetrically with respect to the circumferential center line so as to be stepwise increased on each side of the circumferential center line in the direction.

With this configuration, the hardened cutter inserts are fixed to the outer circumference of the base so as to be arranged at unequal pitches. Accordingly, the time intervals of contact of the hardened cutter inserts with a work can be varied like a sine curve, so that the load on the disk cutter during cutting can be reduced and the occurrence of resonance can also be prevented. As a result, the cutting performance of the disk cutter can be improved.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a side view of a disk cutter according to a preferred embodiment of the present invention.

### DETAILED DESCRIPTION OF THE PREFERRED EMBODIMENTS

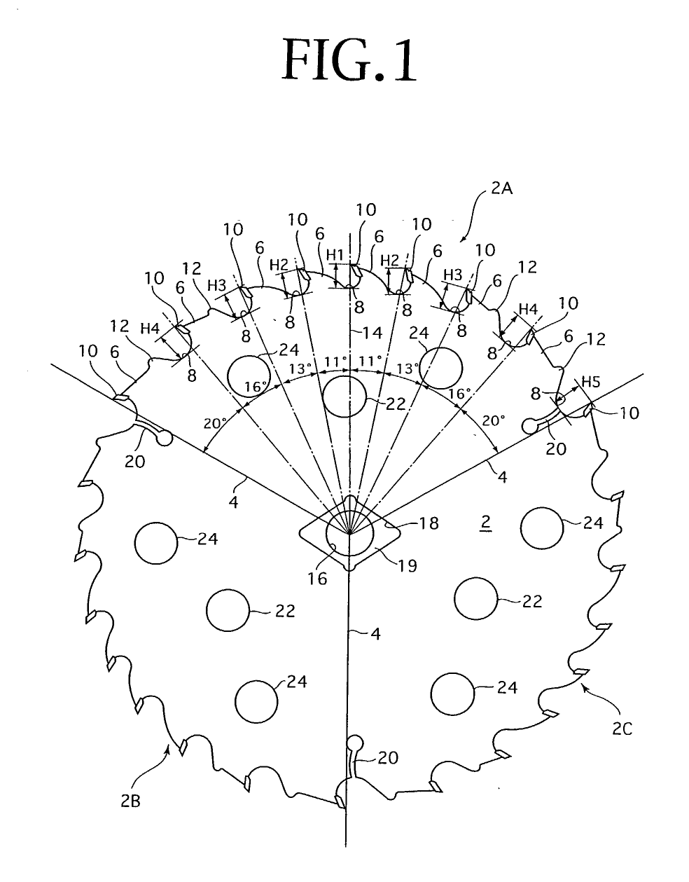

Referring to FIG. 1, there is shown a side view of a disk cutter according to a preferred embodiment of the present invention. The disk cutter has a base disk or annular disk-shaped base 2 imaginarily divided into three segments 2A, 2B, and 2C in the circumferential direction at 120° intervals by three radially extending lines 4. These three segments 2A, 2B, and 2C have the same configuration, so the segment 2A will be mainly described later. The outer diameter of the base disk 2 is 185 mm, for example. The base disk 2 is integrally formed with a plurality of tip supports 6 arranged along the outer circumference of the base disk 2, and a gullet (chip space) 8 is defined between adjacent ones of the tip supports 6.

For example, the base disk 2 has totally twenty-four tip supports 6, and each of the segments 2A, 2B, and 2C accordingly has eight tip supports 6 as shown. The base disk 2 is formed of steel such as JIS SKS51 (alloy tool steel), JIS SK5 (carbon tool steel), or JIS SK6 (carbon tool steel). A hardened cutter insert (cutting tip insert) 10 is brazed to each tip support 6 by silver solder or the like. Each cutter insert 10 is formed of a greatly hard material such as cemented carbide as specified by JIS K10 or K20.

Reference numeral 14 denotes a circumferential center line of the segment 2A. The cutting edge (top) of one of the cutter inserts 10 in the segment 2A lies on the center line 14, and the other cutter inserts 10 in the segment 2A are arranged symmetrically with respect to the center line 14 so that the pitches of the cutter inserts 10 on each side of the center line 14 are stepwise increased in a direction from the center line 14 toward the radially extending line 4 on the same side. More specifically, the cutter inserts 10 are brazed to the respective tip supports 6 so that the angular spacing between the cutting edges of the adjacent cutter inserts 10 on each side of the center line 14 is stepwise increased from 11°, 13°, 16°, and 20° in a direction from the center line 14 toward the radially extending line 4 on the same side.

Furthermore, letting H1 denote the distance between the bottom of the gullet 8 lying on the center line 14 and the cutting edge of the cutter insert 10 lying on the center line 14, i.e., the height of the cutter insert 10 at the center line 14, and H2, H3, H4, and H5 denote the heights of the cutter inserts 10 arranged symmetrically with respect to the center line 14, the heights H1 to H5 of the cutter inserts 10 are set so as to satisfy H1<H2<H3<H4<H5. That is, the heights of the cutter inserts 10, i.e., the depths of the gullets 8, on each side of the center line 14 are stepwise increased in a direction from the center line 14 toward the radially extending line 4 on the same side. For example, the heights H1 to H5 of the cutter inserts 10 are set to H1=8 mm, H2=8.5 mm, H3=9 mm, H4=9.5 mm, and H5=10 mm.

Reference numerals 12 denote limiting teeth formed on some of the tip supports 6 for the cutter inserts 10 arranged at larger pitches. During rotation of the disk cutter in the counterclockwise direction as viewed in FIG. 1, the limiting teeth 12 come into contact with a work to absorb the shock against the cutter inserts 10 on the downstream side of the limiting teeth 12. The base disk 2 has a central mounting hole 16. In operation, a rotating shaft of a rotary tool for wood working, mowing, etc. is inserted into the mounting hole 16 of the base disk 2, thereby mounting the disk cutter to the rotary tool. Reference numeral 18 denotes a rhombic mounting hole, which is opened as required by punching a sheet metal 19 according to the shape of a rotating shaft of a rotary tool to be used.

Further, the disk cutter of this preferred embodiment has three slits 20 formed on the outer circumference of the base disk 2 at 120° intervals. These slits 20 are provided mainly for the purpose of heat dissipation. Further, the base disk 2 is formed with three holes 22 circumferentially arranged at 120° intervals on a circle having a radius of 48 mm about the center of the base disk 2. The base disk 2 is further formed with six holes 24 circumferentially arranged at 60° intervals on a circle having a radius of 65 mm about the center of the base disk 2. These holes 22 and 24 are provided for the purposes of weight reduction and heat dissipation.

The base disk 2 of the disk cutter of this preferred embodiment is manufactured in the following manner. A circular blank for the disk cutter is punched by a press at a 120° sectorial portion corresponding to the segment 2A to thereby form the tip supports 6, the gullets 8, the slit 20, and the holes 22 and 24 of the segment 2A. Thereafter, the blank is similarly punched by the same press to sequentially form the segments 2B and 2C. In this manner, by separately pressing the blank for the base disk 2 to sequentially form the three segments 2A, 2B, and 2C, the press can be reduced in size.

According to the present invention as described above, the hardened cutter inserts are mounted on the outer circumference of the base disk so as to be arranged at unequal pitches. Accordingly, the time intervals of contact of the cutter inserts with a work can be varied like a sine curve. As a result, the load on the disk cutter during cutting can be reduced and the occurrence of resonance can also be prevented.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A disk cutter comprising:
an annular disk-shaped base adapted to be driven about an axis of rotation;
a plurality of tip supports formed along the outer circumference of said base integrally therewith so that a gullet is defined between adjacent ones of said tip supports; and
a plurality of hardened cutter inserts respectively fixed to said tip supports;
said base being imaginarily divided into a plurality of segments by radially extending lines;
said hardened cutter inserts in each segment being arranged symmetrically with respect to a circumferential center line of the segment so that the pitches of said hardened cutter inserts on each side of said circumferential center line are stepwise increased in a direction from said circumferential center line toward said radially extending line on the same side.

2. A disk cutter according to claim 1, wherein the distance between the bottom of each gullet and the top of the corresponding hardened cutter insert is set symmetrically with respect to said circumferential center line so as to be stepwise increased on each side of said circumferential center line in said direction.
